(19) United States
(12) Patent Application Publication
(10) Pub. No.: US 2008/0314474 A1
(43) Pub. Date: Dec. 25, 2008

(54) Dummy Bottle Loader in Apparatus for the Automatic Filling of Containers in Aseptic Conditions and Method for Sanitising Said Apparatus

(76) Inventors: Massimo Balduini, Parma (IT); Massimo Boselli, Parma (IT)

Correspondence Address: PEARNE & GORDON LLP, 1801 EAST 9TH STREET, SUITE 1200, CLEVELAND, OH, 44114-3108, US

(21) Appl. No.: 11/658,637

(22) PCT Filed: Apr. 27, 2005
(86) PCT No.: PCT/IB2005/001178

§ 371 Date: Jan. 26, 2007

(30) Foreign Application Priority Data
Jul. 28, 2004 (IT) PR2004A000053

(51) Int. Cl. B67C 3/00; B08B 9/20

(52) U.S. Cl. 141/1; 141/89; 53/167

(57) ABSTRACT

A loader (1) of dummy bottles (4), able to be used in a cycle of sanitisation of a filler (2), in an apparatus for the automatic filling of containers, comprising containment means which define an aseptic environment in a first portion (11) of the loader (1) connected to the filler (2). A method for sanitising a filler (2) of the type operating in aseptic conditions, by using dummy bottles (4), which provides a step of stowing the dummy bottles (4) in an aseptic portion (11) of a loader (1) and a step of feeding said dummy bottles to the filler (2) in aseptic conditions.

### TECHNICAL FIELD AND BACKGROUND ART

The present invention relates to a dummy bottle loader in an apparatus for the automatic filling of containers in aseptic conditions and method for sanitising said apparatus

In the bottling industry, automatic fillers are used, which must be periodically subjected to sanitisation cycles. To this end, the use of dummy bottles is known, i.e. of containers to be placed underneath the filling valves during the filler sanitisation cycle, to enable to wash the valves and the connected parts. In some cases, the dummy bottles are incorporated in the filler, so they can move from a position of non interference, assumed during the normal operating cycle, to an active position during the sanitisation cycle, as described, e.g., in the patent document EP4097981, or in EP0780338. In other cases, the dummy bottles are contained externally to the filler in a magazine, which allows automatically to feed the dummy bottles to the filler during the sanitisation cycle and to withdraw them at the end of said cycle, to stow them. This technical solution, described for example by the patent document IT1288064, has the advantage that it avoids complicating the mechanical parts of the filler, whose operation can thus be optimised. The magazine, in prior art solutions, comprises a circular structure which houses the dummy bottles, which are located on a single rotatable plane and can moved to be fed to the filler. The number of false bottles which can be housed in said circular structure depends on the dimensions of the magazine, i.e. on the diameter of the circular structure itself. In this light, the main limitation of the technical solution that provides a magazine for dummy bottles that is exterior to the filler is constituted by the size of the magazine itself.

In addition to the aforesaid issues, the bottling industry faces the problem, which oftentimes has fundamental importance, to perform the entire filling process in completely aseptic fashion. In this light, filling apparatuses are known in which the bottles are filled in sterile fashion. Among the known technical solutions in which the dummy bottles are contained in a magazine outside the filler, to make the sanitisation process aseptic, only one solution is known that provides for making sterile the entire environment in which the bottling apparatus is located, i.e. substantially there is an aseptic room containing loader, internal conveyors and filler. However, said technical solution is disadvantageous, or even unfeasible, when the various parts of the apparatus, such as the filler and the dummy bottle magazine, if one is provided, must be easily accessible by the operators.

Therefore, there is the problem of making the sanitisation process sterile as well, i.e. feeding the filler in aseptic fashion with sterile dummy bottles.

### DISCLOSURE OF THE INVENTION

An object of the present invention is to eliminate the aforesaid drawings and to make available an apparatus for the automatic filling of containers in aseptic conditions, comprising a filler of the type operating in aseptic conditions, in which the sanitisation cycles are conducted in sterile mode, actuating the dummy bottles in automatic, without the intervention of operators. Another object of the present invention is to provide an apparatus for the automatic filling of containers in aseptic conditions provided with a dummy bottle magazine having reduced size.

Said objects are fully achieved by the apparatus of the present invention, which is characterised by the contents of the claims set out below and in particular in that said dummy bottle loader comprises containment means that define an aseptic environment connected to the filler.

A further object of the present invention is to make available a method for sanitising a filler of the type operating in aseptic conditions, by using dummy bottles.

Said object is fully achieved by the method of the present invention, which is characterised by the contents of the claims set out below and in particular in that it comprises the following steps:
stowage of the dummy bottles in an aseptic portion of a dummy bottle loader;
feeding the dummy bottles from the loader to the filler in an aseptic environment.

### BEST MODE FOR CARRYING OUT THE INVENTION.

These and other characteristics shall become more readily apparent from the following description of a preferred embodiment, illustrated purely by way of non limiting example in the accompanying drawing tables in which:

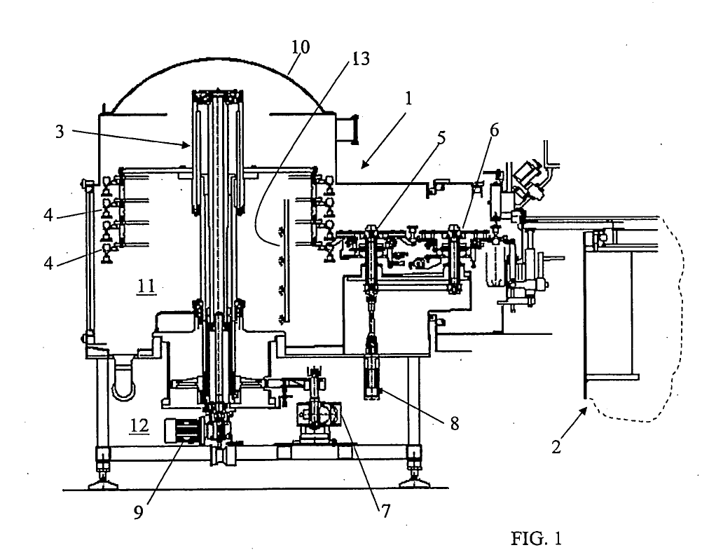

FIG. 1 is a lateral section view of a dummy bottle loader according to the present invention;

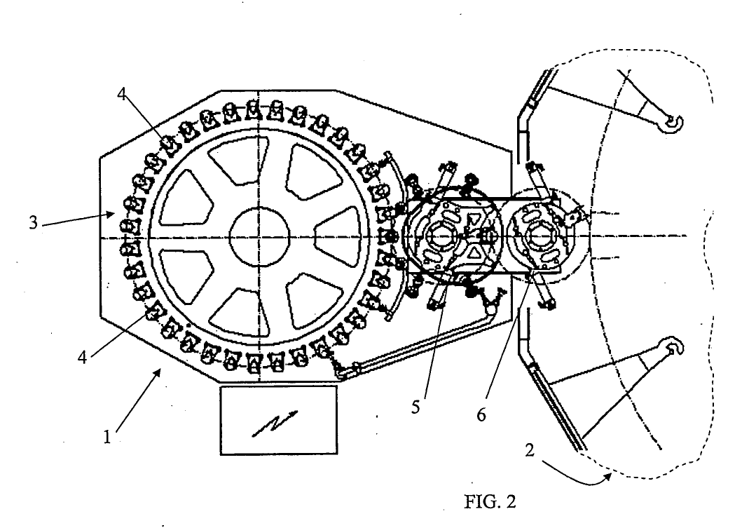

FIG. 2 is a top view of a dummy bottle loader as in FIG. 1.

In the figures, the reference number 1 designates a dummy bottle loader according to the present invention. The reference number 2 designates a filler, of the type with rotating carrousel, only partially illustrated. The loader 1 has the purpose of storing the dummy bottles outside the filler 2 and to move them to feed the filler. Said dummy bottle loader 1 comprises a carrousel 3, in which are set dummy bottle 4; it further comprises first pincers 5, able to rotate and upset the dummy bottles 4 and second pincers 6, able to transfer the dummy bottles 4 to the filler 2. The dummy bottles 4 are located in the carrousel 3, originally, on a plurality of levels or planes, each level housing a plurality of dummy bottles 4. The carrousel 3 is set in rotation by a first motor 7, whilst a second motor 8 actuates the pincers 5 and 6, so that the dummy bottles 4 are picked up from the carrousel 3 and fed to the filler 2, in substantially known fashion. Moreover, the loader 3 comprises a third motor 9, able to raise the carrousel 3. In this way, the dummy bottles can be actuated in a vertical direction, in original fashion, to allow the pincers 5 to pick up dummy bottles housed on different levels in the carrousel 3. The reference number 10 designates a bell, which encloses the loader 1, separating it from the outside environment. Said bell 10, together with other sealing and separating means, isolates a first portion 11 of the loader 1, which is separated from the outside environment and not directly accessible. The bell 10 can be removed, in order to access said portion 11, which comprises, in its volume and substantially to measure, all the elements of the loader that are to be maintained in an aseptic environment. A second portion 12 of the loader 1 comprises, in its volume, other elements of the loader, such as the motors 7, 8 and 9 and other mechanical parts. Said second portion 12 is accessible from the exterior and does not constitute an aseptic environment. The reference number 13 designates nozzles, only partially shown in FIG. 1, for the sterilisation of the portion 11 of the loader 1. In this way, an aseptic environment is obtained that is substantially common to the loader 1 and to the filler 2, the portion 11 of the loader being connected to the filler 2.

Therefore, the dummy bottles 4 are stored and actuated in an aseptic environment, during the sanitisation process. Said aseptic environment is limited, originally, to a portion of the loader 1, so that an operator can have free access to the environment outside the loader 1 and to the filler 2, and to the portion 12 of the loader, within which any maintenance operation can be performed without compromising the sterility of the aseptic environment.

The present invention also makes available a method for sanitising a filler of the type operating in aseptic conditions, which provides for the use of dummy bottles 4. Said method comprises, originally, the following steps:
stowing the dummy bottles 4 in a first aseptic portion 11 of a dummy bottle loader 1;
feeding the dummy bottles 4 from the loader 1 to the filler 2, actuating the dummy bottles within the first aseptic portion 11 of the loader 1.

Said method originally allows to minimise the volume of the sterile environment, with consequent advantage for accessibility to the machinery and for the effectiveness of the sterilisation, since the elements that more easily compromise the aseptic conditions, such as the motors, are positioned outside the aseptic environment and thus their accessibility and periodic actuation can be continued with no need to sterilise the container. It should also be observed that the volume of the aseptic environment is further reduced, originally, thanks to the presence of a multiplicity of levels in the carrousel, which is thus characterised by a smaller diameter, with respect to a single-level carrousel, for equal numbers of dummy bottles housed therein.

1-9. (canceled)

10. Dummy bottle loader comprising a plurality of planes, each of which houses a plurality of dummy bottles (4), characterised in that said dummy bottle loader comprises actuating means for moving said planes along a vertical direction.

11. Loader as claimed in claim 10, wherein the dummy bottles (4) are housed in an upside down position.

12. Apparatus for the automatic filling of containers in aseptic conditions, comprising a filler (2) of the type operating in aseptic conditions and a loader (1) of dummy bottles, able to be used in a process of sanitisation of the filler (2), characterised in that said loader (1) is a loader as claimed in claim 10.

13. A method for sanitising a filler of the type operating in aseptic conditions, which provides for the use of dummy bottles, characterised in that it comprises the following steps:
stowing the dummy bottles (4) in an aseptic portion (11) of a dummy bottle loader (1);
feeding dummy bottles (4) from the loader (1) to the filler (2) in an aseptic environment.

14. A method as claimed in claim 13, which comprises a step of vertically actuating dummy bottles (4), housed in multiple planes in the loader (1).
